(19) United States
(12) Patent Application Publication
(10) Pub. No.: US 2005/0276269 A1
(43) Pub. Date: Dec. 15, 2005

(54) Computer system

(75) Inventor: Moon-kyou Kim, Yeongtong-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/151,403

(22) Filed: Jun. 14, 2005

(30) Foreign Application Priority Data
Jun. 14, 2004 (KR) 2004-0043728

(51) Int. Cl. H04L 12/56

(52) U.S. Cl. 370/395.2; 370/338

(57) ABSTRACT

The present invention relates to a computer system connectable to a network, comprising a wireless communication part having an interface supporting a hot-swappable function and allowing the computer system to be wirelessly connected to the network; a wired communication part having an interface supporting the hot-swappable function and allowing the computer system to be connected to the network by a wire; a power supply for supplying electric power to circuit parts of the computer system; a communication selector allowing a user to select whether the computer system is connected to the network, and for selecting one of the wired communication part and the wireless communication part in order to connect the computer system to the network when the connection of the network is selected; and a controller for cutting offelectric power supplied to the wired communication part and the wireless communication part from the power supply when a disconnection of the network is selected, and to cut off electric power supplied from the power supply to the other communication part which is not selected when one of the communication parts is selected to be used in a network connection on the basis of a selection signal of the communication selector. Thus the present invention provides a computer system that can reduce wasteful loss in electric power.

### CROSS-REFERENCE TO RELATED APPLICATIONS

This application claims the benefit under 35 U.S.C.§ 119(a) of Korean Patent Application No. 2004-0043728, entitled “computer system,” filed on Jun. 14, 2004, the entire disclosure of which is hereby incorporated by reference.

### BACKGROUND OF THE INVENTION

1. Field of the Invention

The present invention relates to a computer system. More particularly, the present invention relates a computer system which reduces wasteful loss in electric power.

2. Description of the Related Art

As the Internet becomes more and more popular, a local area network (LAN) card for a network connection becomes more and more essential in a computer system. The LAN card can be classified into a wired LAN card and a wireless LAN card according to network connection methods.

The wired LAN card is directly connected to a network by a LAN cable, but it is inconvenient to carry a computer system while being connected to the network via a LAN cable. However, the wired LAN card is relatively inexpensive and has a relatively simple circuit, so that most existing portable computers are produced with a built-in wired LAN card.

The wireless LAN card wirelessly connects to an access point connected to a network server, thereby connecting to the network. Recently, the wireless LAN card has been used to enhance the mobility of the portable computer.

Meanwhile, one computer system may comprise both the wired LAN card and the wireless LAN card. In this case, while one of the wired LAN card and the wireless LAN card is used for connecting the computer system to the network, the other one is typically not used.

However, in the conventional computer system, while the wired LAN card is used, the wireless LAN card periodically receives a signal from the access point in order to check the possibility of the network connection, thereby maintaining a connection with the access point and processing its wireless network environment. Therefore, while the wired LAN card is used, the wireless LAN card continuously consumes electric power wastefully. Likewise, in the case where the wireless LAN card is used, the wired LAN card remains in a standby mode and continuously consumes electric power wastefully. Thus, the conventional computer system has a problem in that electric power is continuously supplied to the LAN card not in use, thereby wastefully consuming electric power.

### SUMMARY OF THE INVENTION

Accordingly, embodiments of the present invention provide a computer system which reduces wasteful loss of electric power.

The foregoing and other objects are substantially realized by providing a computer system connectable to a network, comprising a wireless communication part having an interface for supporting a hot-swappable function and allowing the computer system to be wirelessly connected to the network; a wired communication part having an interface for supporting the hot-swappable function and allowing the computer system to be connected to the network by a wire; a power supply for supplying electric power to circuit parts of the computer system; a communication selector for allowing a user to select whether the computer system is connected to the network, and for selecting one of the wired communication part and the wireless communication part in order to connect the computer system to the network when the connection of the network is selected; and a controller for controlling cut off of electric power supplied to the wired communication part and the wireless communication part from the power supply when a disconnection of the network is selected, and cut off of electric power supplied from the power supply to the other communication part which is not selected when one of the communication parts is selected to be used in a network connection on the basis of a selection signal of the communication selector.

The controller may comprise a first switch for switching on or off electric power supplied from the power supply to the wireless communication part, a second switch for switching on or off electric power supplied from the power supply to the wired communication part, and a microcomputer for controlling the first switch and the second switch on the basis of the selection of the communication selector.

The microcomputer may control the first switch and the second switch to cut off electric power supplied to the wireless communication part and the wired communication part from the power supply when the disconnection of the network is selected on the basis of the selection of the communication selector.

The microcomputer may control the first switch and the second switch to supply electric power to one communication part which is selected and to cut off electric power supplied from the power supply to the other communication part which is not selected when the connection of the network is selected and one of the communication parts is selected to be used in the network connection,

The communication selector may comprise a selection key for allowing the user to select whether the computer system is connected to the network, and to select one of the wireless communication part and the wired communication part to be used in the network connection.

Both the wireless and wired communication parts preferably communicate with an ICH through a PCI express interface supporting the hot-swappable function.

Other objects, advantages, and salient features of the invention will become apparent from the detailed description, which, taken in conjunction with the annexed drawings, discloses preferred embodiments of the invention.

### BRIEF DESCRIPTION OF THE DRAWINGS

These and other aspects, features, and advantages of certain embodiments of the present invention will be more apparent and more readily appreciated from the following detailed description, taken with reference to the accompanying drawings, in which:

FIG. 1 is a configuration of a network connection environment using a network connection system of a computer system in accordance with an embodiment of the present invention;

FIG. 2 is a control block diagram of a computer system in accordance with an embodiment of the present invention; and

FIG. 3 is a control flowchart of a computer system in accordance with an embodiment of the present invention.

Throughout the drawings, like reference numbers will be understood to refer to like elements, features and structures.

### DETAILED DESCRIPTION OF EXEMPLARY EMBODIMENTS

The matters defined in the description such as a detailed construction and elements thereof, are provided to assist in a comprehensive understanding of the embodiments of the invention. Accordingly, those of ordinary skill in the art will recognize that various changes and modifications to the embodiments described herein can be made without departing from the scope and spirit of the invention.

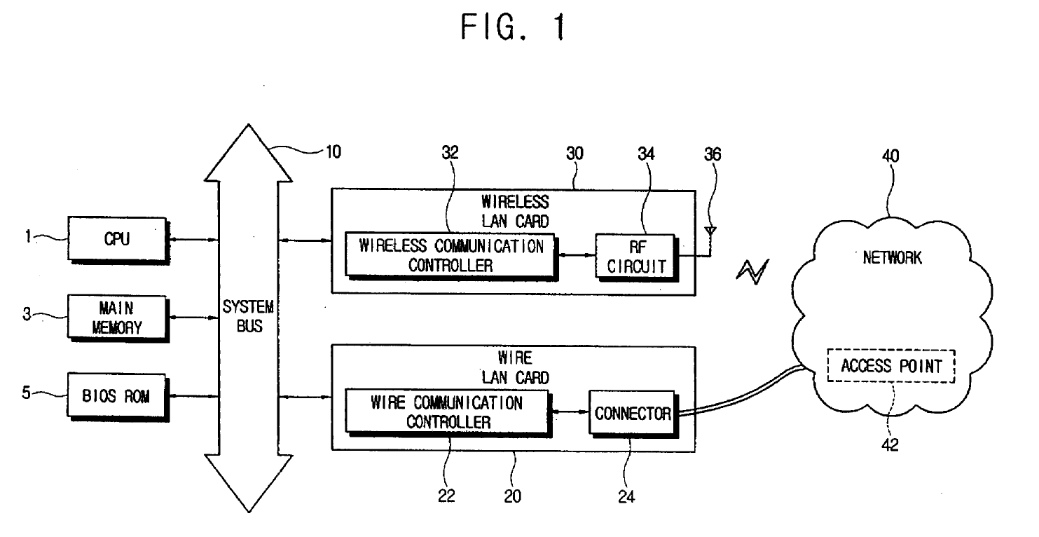

FIG. 1 is a block diagram illustrating a configuration of a network connection environment using a network connection system of a computer system according to an embodiment of the present invention. As shown therein, the network connection system of the computer system according to the embodiment of the present invention comprises a central processing unit (CPU) 1, a main memory 3, a basic input/output system (BIOS) read only memory (ROM) 5 stored with a BIOS, and a system bus 10. The network connection system further comprises a wireless LAN card 30 for wirelessly connecting the computer system to a network 40, and a wired LAN card 20 for connecting the computer system to the network 40 by a wire.

The system bus 10 manages data transfer between the CPU 1 and a memory and between various modules mounted to a peripheral component interconnect (PCI) slot, a PCI Express (hereinafter, referred to as “PCIE”) slot, and the like.

The wireless LAN card 30 and the wired LAN card 20 serve as a wireless communication part as wired communication part, respectively employed as network interface cards for connecting the computer system to the network 40. The wireless LAN card 30 wirelessly connects the computer system to the network 40, thereby allowing the computer system to wirelessly send and receive data through an access point 42 of the network 40. The wired LAN card 20 connects the computer system to the network 40 by a LAN cable, thereby allowing the computer system to send and receive the data through the LAN cable. Here, the wireless LAN card 30 and the wired LAN card 20 are preferably provided as a PC card, and thus can be inserted in an expansion slot of the computer system or mounted as on-board devices onto a mother board of the computer system.

The wireless LAN card 30 comprises an antenna 36 for sending and receiving a wireless signal, a radio frequency (RF) circuit 34, and a wireless communication controller 32 for sending and receiving data through the antenna 36 and the RF circuit 34. The wireless communication controller 32 converts data from the computer system into data adapted to the network 40 and wirelessly sends and receives the converted data to and from the network 40 through the RF circuit 34 and the antenna 36. Furthermore, the wireless communication controller 32 periodically receives a signal from the access point 42 in order to check the possibility of a network connection, thereby maintaining a connection with the access point 42 and checking its network environment.

The wired LAN card 20 comprises a connector 24 to which the LAN cable is connected, and a wired communication controller 22 for sending and receiving data to and from the network 40 through the LAN cable connected to the connector 24. The wired communication controller 22 converts data from the computer system into data adapted to the network 40 and sends the converted data to the network 40 through the LAN cable connected to the connector 24, and receives data from the network 40 through the LAN cable connected to the connector 24.

Thus, the computer system according to an embodiment of the present invention comprises both the wireless LAN card 30 and the wired LAN card 20, so that both the wired connection and the wireless connection are possible. Alternatively, the computer system may comprise either the wireless LAN card 30 or the wired LAN card 20.

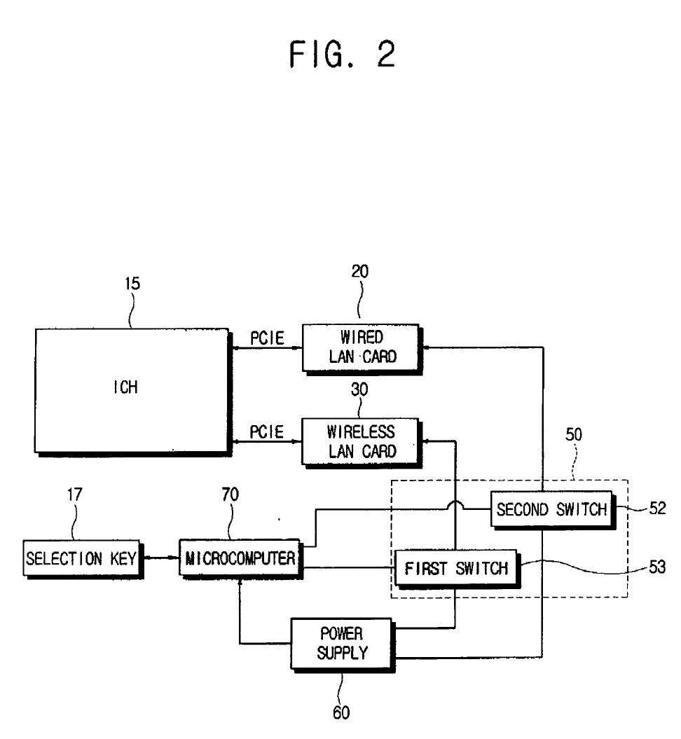

FIG. 2 is a block diagram of a computer system according to an embodiment of the present invention. As shown therein, the computer system according to an embodiment of the present invention comprises an input/output control hub (ICH) 15 for connecting input signals between its various peripheral components such as a key input unit, a touch pad, a wire/wireless network communication parts, and so on; a wired LAN card 20 as a wired communication part and a wireless LAN card 30 as a wireless communication part communicating with the ICH 15 through an interface such as a PCIE interface for an interchip/device connection; a power supply 60 for supplying electric power to circuits of the computer system; a switch 50 for switching on and off electric power supplied from the power supply 60 to the wired LAN card 20 and the wireless LAN card 30; a selection key 17 as a communication selector for allowing a user to select whether the computer system is connected to the network 40 or not, and for selecting one of the wired LAN card 20 or the wireless LAN card 30 in order to connect the computer system to the network 40 when a connection of the network 40 is selected; and a microcomputer 70 as a controller for controlling the switch 50 to cut off electric power supplied to the wired LAN card 20 and the wireless LAN card 30 from the power supply 60 when a disconnection of the network 40 is selected, and to supply electric power to the selected one of the wired LAN card 20 and the wireless LAN card 30 and to cut off electric power supplied to the one which is not selected, when the computer system is connected to the network 40 on the basis of a selection signal of the selection key 17.

In the exemplary embodiment, the PCIE interface substitutes for the PCI interface as the interchip/device connection interface. Of course, those having ordinary skill in the art will recognize that any suitable interface could be used, according to a particular design, and the present invention is not limited to the PCIE interface. The PCIE interface is preferably since it makes higher-speed communication possible as compared with a PCI interface in an interconnection system between devices mounted to the expansion slots. The PCIE interface also allows clock signals for the communication to be different according to the devices, thereby improving the speed of the communication. Further, the PCIE interface allows various devices to communicate with each other at the same time and allows the communication to be performed according to priority of the device.

In Particular, the PCIE interface supports a hot-swappable function, so that the device being operated while the computer system is operated can be rapidly installed to and removed from the computer system, having minimal effect on the operating speed of the computer system.

The switch 50 switches on and off electric power supplied from the power supply 60 to the wired LAN card 20 and the wireless LAN card 30. Further, the switch 50 comprises a first switch 53 for switching on and off electric power supplied from the power supply 60 to the wireless LAN card 30, and a second switch 52 for switching on and off electric power supplied from the power supply 60 to the wired LAN card 20.

The microcomputer 70 controls the first and second switches 53 and 52, to cut off electric power supplied to the wired LAN card 20 and the wireless LAN card 30 from the power supply 60, when the disconnection of the network 40 is selected on the basis of the selection signal of the selection key 17. Further, the microcomputer 70 controls the first and second switches 53 and 52, to thereby supply electric power to one of the wired LAN card 20 and the wireless LAN card 30 selected by the selection key 17 and cut off electric power supplied to the other one which is not selected by the selection key 17, when the computer system is connected to the network 40 on the basis of the selection signal of the selection key 17 and then a corresponding one of the communication parts is selected to be used as the network connection.

Thus, while the computer system according to an embodiment of the present invention is operated, one of the wired LAN card 20 and the wireless LAN card 30 using the PCIE interface, which is not used in the network connection, is disconnected from power (or removed from the computer system), and then repowered (or installed to the computer system) as necessary. At this time, the hot-swappable function of the PCIE interface allows the repowered one of the wired LAN card 20 and the wireless LAN card 30 to rapidly return to its normal operation without delaying time taken until the repowered one normally operates due to the repowering (installation).

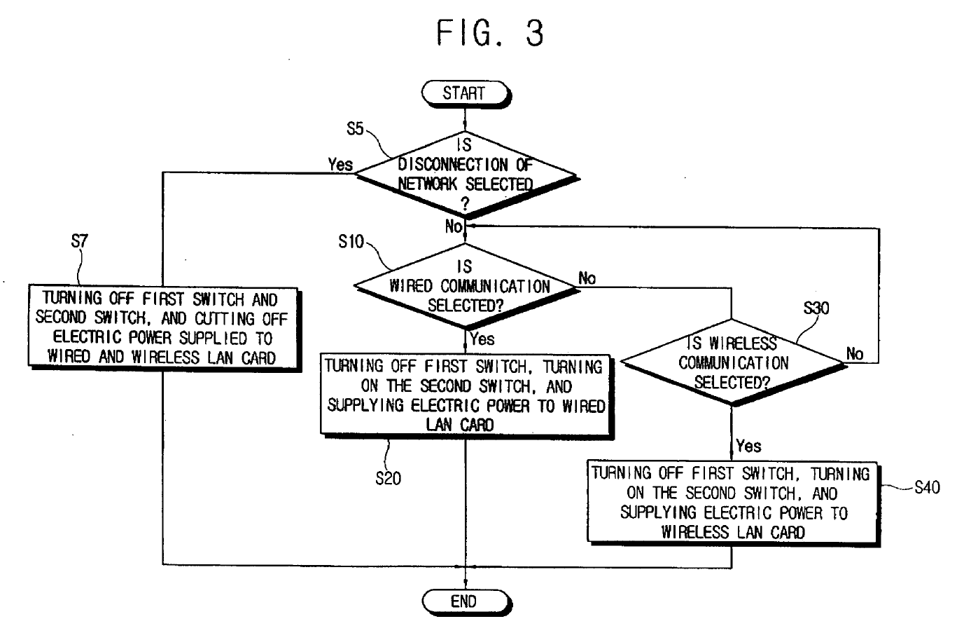

With this configuration, a method of controlling the computer system will be described with reference to FIG. 3. First, at operation S5, the microcomputer 70 determines that the disconnection of the network 40 is selected on the basis of the selection signal outputted from the selection key 17. At operation 7, when the disconnection of the network 40 is selected, the microcomputer 70 turns off both the first switch 53 and the second switch 52, thereby cutting off electric power supplied to the wired LAN card 20 and the wireless LAN card 30. When the disconnection of the network 40 is not selected, the microcomputer 70 determines which one between the wired communication and the wireless communication is selected on the basis of the selection signal output from the selection key 17. At operation S10, when it is determined that wired communication is selected, at operation S20, the microcomputer 70 turns off the first switch 53 and turns on the second switch 52, thereby supplying electric power to the wired LAN card 20 and cutting off electric power supplied to the wireless LAN card 30. At operation S30, when it is determined that the wireless communication is selected, at operation S40, the microcomputer 70 turns on the first switch 53 and turns off the second switch 52, thereby supplying electric power to the wireless LAN card 30 and cutting off electric power supplied to the wired LAN card 20.

In the foregoing embodiment, when either the wired communication or the wireless communication is selected, electric power is supplied to one of the wired and wireless LAN cards corresponding to the selected communication but is not supplied to the other one. When a user does not want the network connection and selects both the wired and wireless communication to be turned off through the selection key 17, electric power is cut off to both the wired and wireless LAN cards.

Consequently, when the computer system is connected to the network 40 through the wired LAN card 20, the wireless LAN card 30 is not powered. In this case, the wireless LAN card 30 does not wastefully consume electric power in checking the possibility of the network connection by periodically receiving a signal from the access point in order to maintain connection with the access point 42 and process its network environment. On the other hand, when the computer system is connected to the network 40 through the wireless LAN card 30, the wired LAN card 20 is not powered. In this case, the wired LAN card 20 does not wastefully consume electric power in its standby mode. Further, when disconnection of the network 40 is selected, the computer system cuts off electric power supplied to both the wired LAN card 20 and the wireless LAN card 30, thereby reducing wasteful loss in electric power in the wired LAN card 20 and the wireless LAN card 30.

As described above, embodiments of the present invention provide a computer system that can reduce wasteful loss in electric power.

While the invention has been shown and described with reference to certain embodiments thereof, it will be understood by those skilled in the art that various changes in form and details may be made therein without departing from the spirit and scope of the invention as defined by the appended claims.

1. A computer system connectable to a network, comprising:
a wireless communication part having an interface for supporting a hot-swappable function and allowing the computer system to be wirelessly connected to the network;
a wired communication part having an interface for supporting the hot-swappable function and allowing the computer system to be connected to the network by a wire;
a power supply for supplying electric power to circuit parts of the computer system;
a communication selector for allowing a user to select whether the computer system is connected to the network, and for selecting one of the wired communication part and the wireless communication part in order to connect the computer system to the network when the connection of the network is selected; and
a controller to cut off the electric power supplied to the wired communication part and the wireless communication part from the power supply when a disconnection of the network is selected, and to cut off electric power supplied from the power supply to the other communication part which is not selected when one of the communication parts is selected to be used in a network connection on the basis of a selection signal of the communication selector.

2. The computer system according to claim 1, wherein the controller comprises:
a first switch for switching on and off electric power supplied from the power supply to the wireless communication part;
a second switch for switching on and off electric power supplied from the power supply to the wired communication part; and
a microcomputer for controlling the first switch and the second switch on the basis of the selection of the communication selector.

3. The computer system according to claim 2, wherein the microcomputer controls the first switch and the second switch to cut off electric power supplied to the wireless communication part and the wired communication part from the power supply when disconnection of the network is selected on the basis of the selection of the communication selector.

4. The computer system according to claim 3, wherein the microcomputer controls the first switch and the second switch to supply electric power to one of said communication parts which is selected and to cut off electric power supplied from the power supply to the other of said communication parts which is not selected when the connection of the network is selected and one of the communication parts is selected to be used in the network connection.

5. The computer system according to claim 4, wherein the communication selector comprises a selection key allowing the user to select whether the computer system is connected to the network, and to select one of the wireless communication part and the wired communication part to be used in the network connection.

6. The computer system according to claim 5, wherein both the wireless and wired communication parts communicate with an ICH through a PCI express interface supporting the hot-swappable function.

7. The computer system according to claim 1, wherein both the wireless and wired communication parts communicate with an ICH through a PCI express interface supporting the hot-swappable function.

8. A method of controlling a computer system having a wired communication part and a wireless communication part comprising the steps of:
determining whether disconnection to a network is desired, and cutting off power to both the wired communication part and the wireless communication part based on said determination;
if connection to a network is desired; determining whether wired communication is selected;
supplying power to a wired communication part and cutting off power to a wireless communication part if wired communication is selected; and
supplying power to a wireless communication part and cutting off power to a wired communication part if wireless communication is selected.

9. The method of claim 8, wherein the step of supplying power to a wired communication part comprises:
controlling a first switch connected between a power supply and said wired communication part to supply power to the wired connection; and
controlling a second switch connected between said power supply and said wireless communication part to cut off power to the wireless connection.

10. The method of claim 8, wherein the step of supplying power to a wireless communication part comprises:
controlling a first switch connected between a power supply and said wired communication part to cut off power to the wired connection; and
controlling a second switch connected between said power supply and said wireless communication part to supply power to the wireless connection.
